(19) United States
(12) Patent Application Publication
(10) Pub. No.: US 2007/0121633 A1
(43) Pub. Date: May 31, 2007

(54) Active-active fibre channel capability in SATA and SAS devices

(76) Inventors: Michael Moretti, Palo Alto, CA (US); Kelvin Kao, San Jose, CA (US)

Correspondence Address: RAJ ABHYANKER, LLP;c/o PORTFOLIOIP, P.O. BOX 52050, MINNEAPOLIS, MN, 55402, US

(21) Appl. No.: 11/291,116

(22) Filed: Nov. 30, 2005

(51) Int. Cl. H04L 12/56

(52) U.S. Cl. 370/392; 370/466

(57) ABSTRACT

Active-active fibre channel capability in SAS and SATA apparatus and method is disclosed. In one embodiment, a storage device includes a dongle having a conversion module to translate between a fibre channel frame and a SATA frame and/or a SAS frame, and a data processing system to communicate through a fibre channel network with the storage device through two or more ports on the conversion module. An active-active module of the conversion module may provide multiple paths from the data processing system to the storage device. The conversion module may process the fibre channel frame and other fibre channel frames on a frame by frame basis. The dongle may be external to the storage device.

### FIELD OF TECHNOLOGY

This disclosure relates generally to the technical fields of storage environments, in one example embodiment, to an active-active fibre channel capability in SAS and SATA apparatus and method.

### BACKGROUND

Fibre channel is a high performance serial link supporting its own, as well as higher-level protocols such as the Fiber Distributed Data Interface (FDDI), Small Computer System Interface (SCSI), High-Performance Parallel Interface (HIPPI), and Internet Policy Institute (IPI) protocols. Fibre channel is often used as a transport mechanism in storage area networks (SANs) in which personal computers and servers are connected to storage devices and other peripherals through a fibre channel transport. By moving storage to a SAN, administrators have the bandwidth to share and/or allocate storage to a much larger audience on a network. The fibre channel transport mechanism can often be used because it allows for fast transfer of large amounts of information to and from nodes of a SAN.

Serial Advanced Technology Attachment (serial ATA) devices (e.g., SATA hard drives) are frequently used as storage devices in personal computers. Consequently, serial ATA devices are manufactured in very high volumes. Fibre channel devices (e.g., specialized fibre channel hard drives based on the SCSI standard) are manufactured in low volumes, because they are primarily used in SAN environments. As a result, serial ATA devices tend to be less costly than fibre channel devices because of reasons including economies of scale achieved through higher volume production of serial ATA devices. For example, component costs for serial ATA devices can cost 3-5 times less than the cost of components for fibre channel devices. In addition, serial ATA devices have a thin serial cable that facilitates more efficient airflow inside a form factor and also allows for smaller chassis designs.

Serial Attached SCSI (SAS) is a serial communication protocol for storage devices. SAS uses serial communication instead of the parallel method found in many SCSI devices but still uses SCSI commands for interacting with SAS devices. SAS supports up to 16,384 addressable devices in a SAS domain and point to point data transfer speeds up to 3 Gbit/s (e.g., in the future may be higher than 10 Gbit/s). The SAS connector is much smaller than traditional parallel SCSI connectors allowing for small 2.5 inch drives.

Serial ATA and SAS devices cannot work in environments where fibre channel is used as a transport mechanism, because the fibre channel standard does not support serial ATA and SAS protocols.

### SUMMARY

Active-active fibre channel capability in SAS and SATA is disclosed. In one aspect, a system includes a dongle having a conversion module to translate between a fibre channel frame and a SATA frame and/or a SAS frame, and a data processing system to communicate through a fibre channel network with a storage device associated with the dongle through two or more ports on the conversion module. The dongle may be external to the storage device.

The conversion module may process the fibre channel frame and/or other fibre channel frames on a frame by frame basis. An expected frame header may also be created. When a new frame enters the conversion module, a comparison can be made of the expected frame header (e.g., derived from the previous frame), and the new frame's header (e.g., to quickly validate it against the previous next frame state). An expected frame state may be maintained to anticipate and/or expedite one or more of an expected fibre channel frame, an expected SATA frame, and an expected SAS frame processed by the conversion module. The expected frame state may be created prior to forwarding the next fibre channel frame, the next SATA frame, and/or the next SAS frame, such as by performing a protocol validation through at least one header validation operation.

An active-active module of the conversion module may provide multiple paths from the data processing system to the storage device, and enable the processing of 128 concurrent commands from at least 32 data processing systems through a processor having separate payload buffers for data throughput from queue structures for processing header information.

A mapping module of the conversion module may translate a LBA (logical block address) and a LBA count in a SCSI command from the data processing system that assumes the command is for a 520 block, a 524 block, and/or a 528 block hard disk to the proper LBA count for a 512 block SATA disk. The mapping module may flow through the translation while a next fibre channel frame, a next SATA frame, and/or a next SAS frame is processed by the conversion module.

A context may be associated with at least one outstanding command, and the context may include information such as a MTU size, a SAS hash address, a fibre channel source identifier, an expected state, a pointer allocation for putting on queue, and/or a command descriptor block (CDB). The context may be of a fixed size and/or the context may be allocated prior to receiving the fibre channel frame and other fibre channel frames.

In another aspect, a method includes analyzing an incoming command of an initiator and performing a conversion of the incoming command to a format of an output line, determining whether the incoming command is compatible with the output line, processing the incoming command internally by applying an algorithm when it is incompatible with the output line, and communicating the incoming command to a destination device associated with the output line when it is compatible with the output line. An expected state of a next frame of this command from the initiator may be updated using data provided in the command. An incoming frame may be validated using a SAS, SATA, and/or a fibre channel protocol. In addition, a sender of the frame may be validated using a SCSI protocol. A header data of the command may be processed in at least one queue structure, and a payload data of the command may be processed in at least one payload buffer.

In a further aspect, a system includes a data processing system coupled to two or more SAS devices and/or SATA devices through a first fibre channel network and a second fibre channel network, a first translation dongle to process data between at least one of the SAS devices and the data processing system through the first fibre channel network and the second fibre channel network, and a second translation dongle to process data between at least one of the SATA devices and the data processing system through the first fibre channel network and the second fibre channel network. The second translation dongle may include at least two ports that provide multiple paths between one or more of the SATA devices and the data processing system.

The methods may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the Figures of the accompanying drawings, in which like references indicate similar elements and in which:

FIG. 1 is a block diagram of a dongle having multiple fibre channel ports and a SATA port, according to one embodiment.

FIG. 2 is a block diagram of a dongle having multiple fibre channel ports and multiple SAS ports, according to one embodiment.

FIG. 3 is a network diagram of the dongles of FIG. 1 and FIG. 2 operating in a fibre channel environment, according to one embodiment.

FIG. 4 is a block diagram of data segmentation, queuing, and buffering in the dongle, according to one embodiment.

FIG. 5 is a perspective view of a storage device associated with a dongle, according to one embodiment.

FIG. 6 is a diagrammatic representation of a data processing system capable of processing a set of instructions to perform any one or more of the methodologies herein, according to one embodiment.

FIG. 7 is a process flow of conversion between fibre channel and SATA signals from the fibre channel side, according to one embodiment.

Other features of the present embodiments will be apparent from the accompanying drawings and from the detailed description that follows.

### DETAILED DESCRIPTION

Active-active fibre channel capability in SAS and SATA apparatus and method is disclosed. In the following description, for purposes of explanation, numerous specific details are set forth in order to provide a thorough understanding of the various embodiments. It will be evident, however, to one skilled in the art that the various embodiments may be practiced without these specific details. An example embodiment provides methods and systems for a storage device that includes a dongle having a conversion module to translate between a fibre channel frame and a SATA frame and/or a SAS frame, and a data processing system to communicate through a fibre channel network with the storage device through two or more ports on the conversion module. Example embodiments of a method and a system, as described below, may be used to provide active-active fibre channel capability for SATA and SAS devices. It will be appreciated that the various embodiments discussed herein may/may not be the same embodiment, and may be grouped into various other embodiments not explicitly disclosed herein.

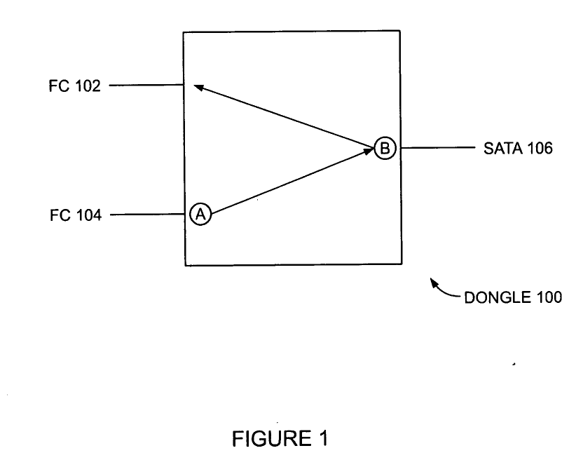

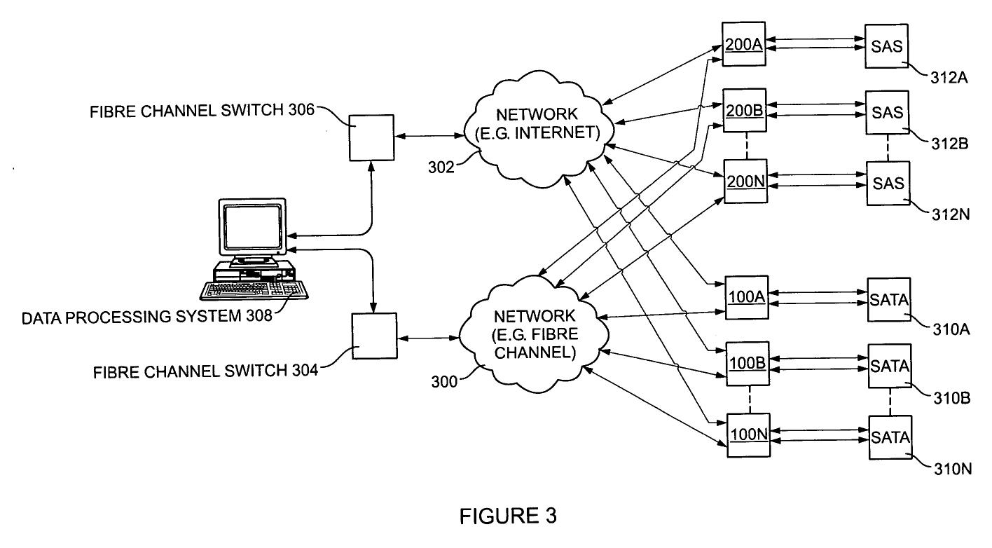

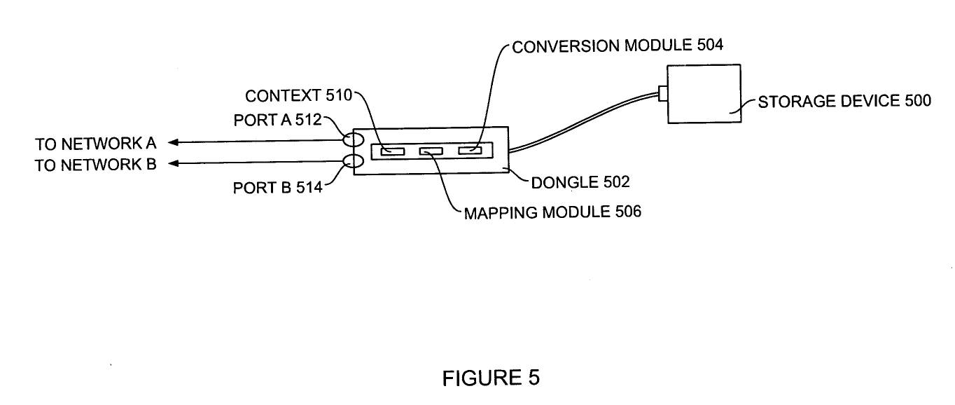

FIG. 1 is a block diagram of a dongle 100 having multiple fibre channel ports (a fibre channel port 102 and a second fibre channel port 104) and a SATA port 106, according to one embodiment. The fibre channel port 102 and the fibre channel port 104 may connected to different fibre channel switches. For example, the fibre channel port 102 may be connected to a fibre channel switch 304 in FIG. 3, whereas the fibre channel port 104 may be connected to a fibre channel switch 306 in FIG. 3. The SATA port 106 may be connected to a SATA storage device, such as a SATA hard drive (e.g., such as a SATA hard drive 310A). In an alternate embodiment, the SATA port may be connected to circuitry in a dongle (e.g., a dongle 502 as illustrated in FIG. 5), and external to a storage device (e.g., the storage device 500 as illustrated in FIG. 5).

Illustrated in FIG. 1 is a circle ‘A’ near the fibre channel port 104. The circle ‘A’ represents a communication path of frames of data from the fibre channel port 104 to the SATA port 106. First, a validation occurs of an initiator of a particular frame. For example, an initiator may be a data processing system 308 as illustrated in FIG. 3, and the dongle 100 may validate that a particular source identifier is associated with the data processing system 308 when a frame is received from the fibre channel port 104.

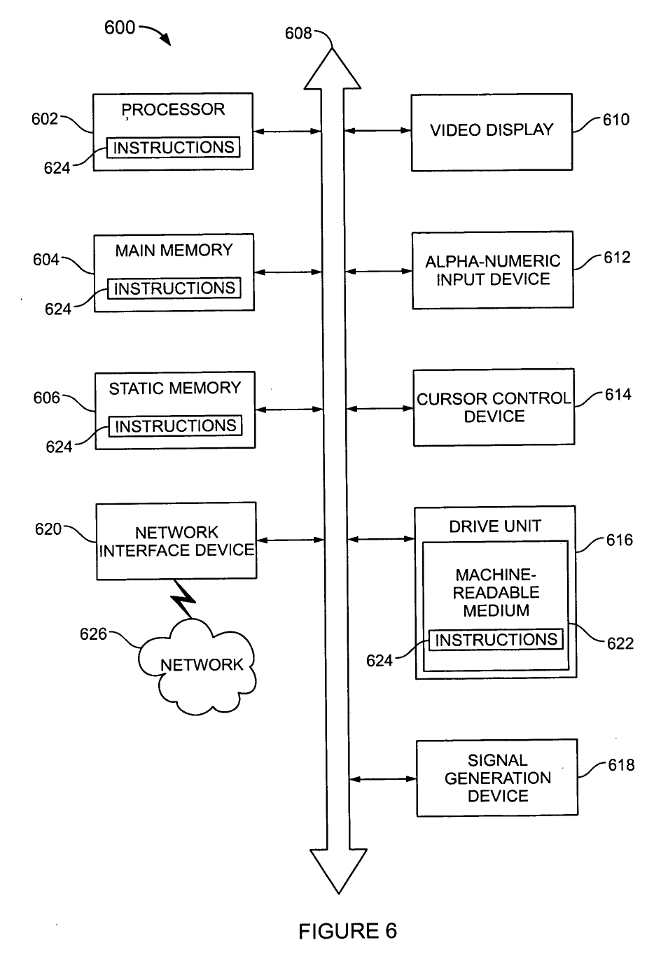

It should be noted that data flows through the dongle 100 and only the command is translated in one embodiment. Also, a frame size validation can be made. For example, a mapping module 506 of FIG. 5 (e.g., in a conversion module 504 of FIG. 5) of the dongle 100 may flow through the translation of the data (e.g., the conversion module 504 may translate a LBA and a LBA count in a SCSI command from the data processing system that assumes the command is for a 520 block, a 524 block, and/or a 528 block hard disk to the proper LBA count for a 512 block SATA disk). After the validation is made, an interpretation is made whether the incoming fibre channel frame includes a payload having a command that can be processed by a SATA protocol (e.g., read, write). If not, the dongle 100 may process incompatible commands (e.g., a verify command) internally (e.g., using a processor such as the processor 602 of FIG. 6), and return a response to an initiator (e.g., the data processing system 308 of FIG. 3.

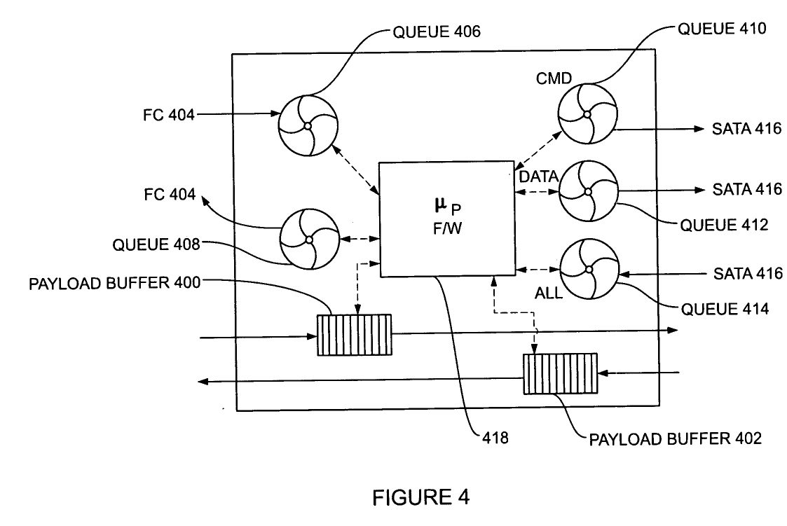

If the data is a compatible command, the dongle 100 may convert the command from a fibre channel protocol to a serial ATA protocol (e.g., using a logic 418 as illustrated in FIG. 4). In one embodiment, data received from the fibre channel port 102 and/or the fibre channel port 104 may provide multiple paths for load balancing or throughput purposes and a combined throughput from the multiple paths set may be provided to SATA hard drive (e.g., the SATA hard drive 310A of FIG. 3) connected the SATA port 106.

As a result, the SATA hard drive (e.g., the SATA hard drive 310A of FIG. 3) may work similarly in an active-active mode, or a mode that enables the SATA hard drive to provide multiple paths from the data processing system (e.g., the data processing system 308) to the storage device (e.g., while two ports are illustrated in FIG. 1, alternate embodiments of the dongle 100 of FIG. 1 may have any number of fibre channel ports). The data processing system 308 may not know that he is associated with a SATA hard drive, the data processing system 308 may believe that he is associated with a dual ported fibre channel drive, according to one embodiment. In another alternate embodiment, if a network associated with the fibre channel port 102 fails (e.g., a network 300 of FIG. 3), than data may be transmitted over an alternate network over the fibre channel port 104 (e.g., such as over a network 302 as illustrated in FIG. 3).

In addition, illustrated in FIG. 1 is a circle ‘B’ near the SATA port 106. In the operation of circle ‘B’, the dongle 100 may check if a particular frame received is an expected by examining stored information from a previous frame having data about a next expected frame (e.g., a previous frame sent from a SATA device through the dongle 100A of FIG. 3 to the data processing system 308 of FIG. 3). Also, the dongle 100 may determine a particular command context (e.g., a set of attributes that give a meaning/value/parameters to a particular type of command). A validation may then be made of the frame (e.g., by checking if identification information of the header is what was expected). Then, the frame may be converted into a fibre channel frame from a SATA frame and sent out over either the fibre channel port 102 and/or the fibre channel port 104 (e.g., by using the logic 418 of FIG. 4).

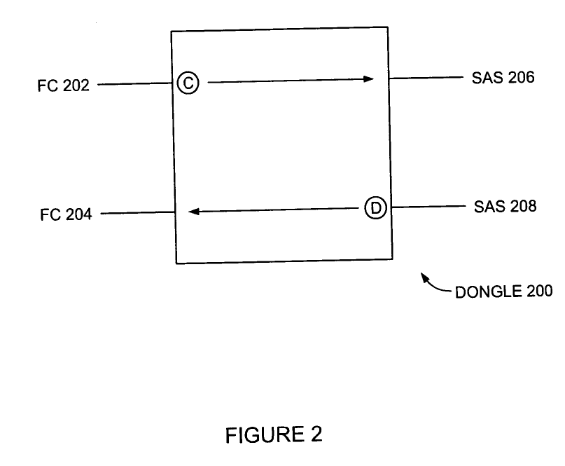

FIG. 2 is a block diagram of a dongle 200 having multiple fibre channel ports (e.g., a fibre channel port 202 and a fibre channel port 204) and multiple SAS ports (e.g., a SAS port 206 and a SAS port 208), according to one embodiment. The dongle 200 may be similar to dongle 100, but used to convert between fibre channel frames and SAS frames (e.g., in both directions), rather than between fibre channel frames and SATA frames (e.g., in both directions).

Illustrated in FIG. 2 is a circle ‘C’ near the fibre channel port 202. The operations of circle ‘C’ may involve the translation (e.g., conversion, processing) from fibre channel frames to SAS frames. First, an initiator (e.g., the data processing system 308) may be validated. Then the frame header (e.g., a frame header of an incoming fibre channel frame) may be validated (e.g., using an algorithm that examines a header having a source identifier). Next, an expected next header state may be updated (e.g., so the dongle 200 knows what type of frame to expect next). Then, the fibre channel frame may be converted to a SAS frame, and sent through the dongle 200.

In addition, illustrated in FIG. 2 is a circle ‘D’ near the SATA port 208. The operations of circle ‘D’ may involve translation (e.g., conversion, processing) from SAS frames to SATA frames. First, a frame header may be validated (e.g., similarly to the process discussed in circle ‘C’). Then an expected next state may be updated. A conversion may be then made to an outgoing fibre channel frame (e.g., by reformatting the data into the appropriate frame size, and modifying header information). Finally, the data may be transmitted through the fibre channel port 202 and/or the fibre channel port 204.

FIG. 3 is a network diagram of the dongles of FIG. 1 and FIG. 2 operating in a fibre channel environment, according to one embodiment. Illustrated in FIG. 3 is a network 300, and a network 302. Data processing system 308 is coupled to the network 300 (e.g., internet) through the fibre channel switch 304, and data processing system 308 is coupled to the network 302 (e.g. fibre channel) through the fibre channel switch 306. In case the network 300 associated with the fibre channel switch 304, then data may be transmitted over an alternate network 302 over the fibre channel switch 306.

SATA drives 310A, 310B, to 310N and SAS drives 312A, 312B, to 312N are coupled to network 300 and network 302 through dongles 100A, 100B, to 100N, that are different versions of dongle 100 of FIG. 1, and also multiple versions of dongle 200 of FIG. 2 200A,200B, to 200N respectively. The dongles 100A, 100B, to 100N process data between the SATA drives 310A, 310B, to 310N and the network 300, and the dongles 200A, 200B, to 200N process data between the SAS drives 312A, 312B, to 312N and the network 302.

Data may be sent from the data processing system 308 through the fibre channel switch 306 and the network 302 into the dongle 100A in one port, and also from the data processing system 308 to the fibre channel switch 304 to the network 300 to the other port on the dongle 100A. Thus the dongle 100A may receive two inputs, one from the network 302, and one from the network 300. The SATA drives 310A, 310B, to 310N have single ports, however throughput of multiple fibre channel frames processed across different ports may enable multiple paths through the dongles 100A, 100B, to 100N (e.g., fibre channel frames processed across 2 ports as shown in FIG. 1), thereby enabling the SATA drives to work in an active-active mode.

FIG. 4 is a block diagram of data segmentation, queuing, and buffering in the dongle, according to one embodiment. Shown in FIG. 4 are queues 406, 408,410,412 and 414, which are coupled with logic 418, where commands are converted from a fibre channel protocol 404 to a serial ATA protocol 416. Fibre channel commands are received into queue 406. These commands may be received from an initiator (e.g., the data processing system 308 of FIG. 3). Output headers are transmitted out from the queue 408 to the fibre channel 404. SATA signals are sent from SATA 416 to the queue 414, where the header information (e.g., which may be used to control link applications, control device protocol transfers, and detect missing or out of order frames) is stored and processed. The converted commands or the compatible commands are sent from the logic 418 to the queues 410 and 412, from where they are transmitted to the SATA 416. Payload (e.g., information to be transferred from a source port to a destination port) from the fibre channel side is sent directly into the payload buffer 400, and payload from the SATA 416 side is sent into the payload buffer 402 for data throughput.

FIG. 5 is a perspective view of a storage device 500 associated with a dongle 502, according to one embodiment. As illustrated in FIG. 5, the dongle 502 includes a conversion module 504, which further includes a mapping module 506, an active-active module 508, and a context 510. There are two ports illustrated with the dongle 502, a port A 512 and a port B 514 (e.g., fibre channel ports such as the fibre channel port 202 and the fibre channel port 204 of FIG. 2). The port A 512 connects the dongle 502 to a network A, while the port B 514 connects the dongle to a network B. The storage device 500 of FIG. 5 is connected to a dongle 502 (e.g., the dongles 200A to 200N or the dongles 100A to 100N of FIG. 3).

The conversion module 504 may translate between a fibre channel frame and a SATA frame and/or a SAS frame. The fiber channel frame may contain the information to be transmitted (e.g., payload), the address of the source and destination ports and link control information. In at least one embodiment, the conversion module 504 may process the fibre channel frame on a frame by frame basis. In addition, a next frame state may be maintained to anticipate and/or expedite one or more of a next fibre channel frame, a next SATA frame, and a next SAS frame processed by the conversion module. The next frame state may be validated prior to forwarding the next fibre channel frame, the next SATA frame, and/or the next SAS frame, such as by performing a protocol validation through at least one header validation operation.

An active-active module of the conversion module may provide multiple paths from the data processing system to the storage device, and enable the processing of 128 concurrent commands from at least 32 data processing systems through a processor having separate payload buffers for data throughput from queue structures for processing header information.

A mapping module of the conversion module may translate at least one of a 520 block, a 524 block and a 528 block size of a SCSI data in the fibre channel frame to a 512 block SATA frame. The mapping module may flow through the translation while a next fibre channel frame, a next SATA frame, and/or a next SAS frame is processed by the conversion module.

A context (e.g., 132 frames of data) may be associated with at least one outstanding command, and the context may include information such as a MTU size, a SAS hash address, a fibre channel source identifier, an expected state, a pointer allocation for putting on queue, and/or a command descriptor block (CDB). The context may be of a fixed size and/or the context may be allocated prior to receiving the fibre channel frame and other fibre channel frames.

FIG. 6 shows a diagrammatic representation of machine in the example form of a computer system 600 within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 600 includes a processor 602 (e.g., a central processing unit (CPU) a graphics processing unit (GPU) and/or both), a main memory 604 and a static memory 606, which communicate with each other via a bus 608. The computer system 600 may further include a video display unit 610 (e.g., a liquid crystal display (LCD) and/or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies and/or functions described herein. The software 624 may also reside, completely and/or at least partially, within the main memory 604 and/or within the processor 602 during execution thereof by the computer system 600, the main memory 604 and the processor 602 also constituting machine-readable media.

The software 624 may further be transmitted and/or received over a network 626 via the network interface device 620.

While the machine-readable medium 622 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

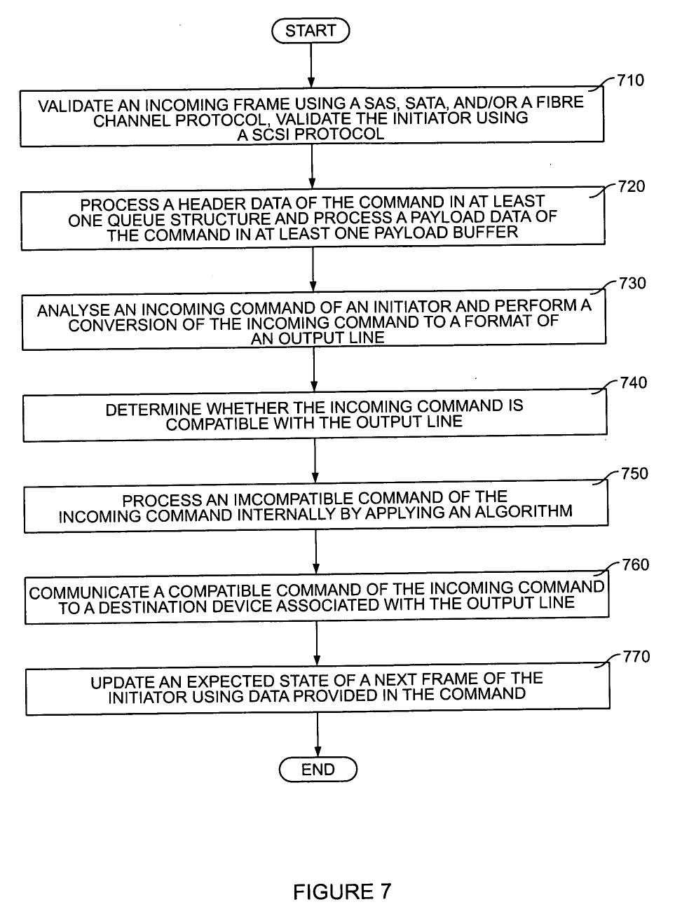

FIG. 7 is a process flow of conversion between fibre channel and SATA signals from the fibre channel side, according to one embodiment. In operation 710, an incoming frame is validated using SAS, SATA, and/or a fibre channel protocol, and the initiator is validated using a SCSI protocol (e.g., by the logic 418). Then in operation 720, a header data is processed in one or more queue structures (e.g., the queue 406), and a payload data is processed in one or more payload buffers (e.g., the payload buffer 402). In operation 730, an incoming command of an initiator (e.g., the data processing system 308 of FIG. 3) is analyzed and a conversion of the incoming command is made to a format of an output line (e.g., the output line may the fibre channel line connected to the dongle 100 of FIG. 1). In operation 740, a determination is made whether the incoming command is compatible with the output line (e.g., the SATA/SAS side of the dongle 100/200). If the incoming command is incompatible, in operation 750, the incompatible command is internally processed by applying an algorithm. In operation 760, a compatible command is communicated to a destination device (e.g., a hard drive) associated with the output line. In operation 770, an expected state is updated of a next frame of the initiator using data provided in the command.

Although the present embodiments have been described with reference to specific example embodiments, it will be evident that various modifications and changes may be made to these embodiments without departing from the broader spirit and scope of the invention. For example, the various modules, dongles, contexts, queues, buffers, networks, etc. described herein may be performed and created using hardware circuitry (e.g., CMOS based logic circuitry), firmware, software and/or any combination of hardware, firmware, and/or software.

For example, the dongle 100/200/502, the logic 418, the payload buffers 400/402, the queues 406-414, the conversion module 504, the mapping module 506, the context 510, etc. may be embodied using transistors, logic gates, and electrical circuits (e.g., application specific integrated ASIC circuitry) using an dongle circuit, a logic circuit, the payload buffer circuit, a queue circuit, a conversion circuit, a mapping circuit, a context circuit, etc. In addition, it will be appreciated that the various operations, processes, and methods disclosed herein may be embodied in a machine-readable medium and/or a machine accessible medium compatible with a data processing system (e.g., a computer system). Accordingly, the specification and drawings are to be regarded in an illustrative rather than a restrictive sense.

What is claimed is:

1. A system, comprising:
a dongle having a conversion module to translate between a fibre channel frame and at least one of a SATA frame and a SAS frame; and
a data processing system to communicate through a fibre channel network with a storage device associated with the dongle through at least two ports on the conversion module.

2. The system device of claim 1 further comprising an active-active module of the conversion module to provide multiple paths from the data processing system to the storage device.

3. The system of claim 2 wherein the active-active module to enable the processing of 128 concurrent commands from at least 32 data processing systems through a processor having separate payload buffers for data throughput from queue structures for processing header information.

4. The system of claim 1 wherein the dongle is external to the storage device.

5. The system of claim 1 wherein the conversion module to process the fibre channel frame and other fibre channel frames on a frame by frame basis.

6. The system of claim 5 wherein the context is associated with at least one outstanding command.

7. The system of claim 6 wherein the context includes information comprising a MTU size, a SAS hash address, a fibre channel source identifier, an expected state, a pointer allocation for putting on queue, a command descriptor block (CDB).

8. The system of claim 7 wherein the context is of a fixed size and wherein the context is allocated prior to receiving the fibre channel frame and other fibre channel frames.

9. The system or claim 1 wherein an expected frame state is maintained to anticipate and expedite at least one of an expected fibre channel frame, an expected SATA frame, and an expected SAS frame processed by the conversion module.

10. The system of claim 9 wherein the expected frame state is created prior to forwarding the at least one of the next fibre channel frame, the next SATA frame, and the next SAS frame.

11. The system of claim 10 wherein the expected frame validation includes performing a protocol validation through at least one header validation operation.

12. The system of claim 1 further comprising a mapping module of the conversion module to translate a logical block address and a logical block address count between at least one of a 520 block, a 524 block, and a 528 hard disk SCSI command to a corresponding address and count for a 512 block SATA disk.

13. The system of claim 12 wherein the mapping module to flow through the translation while at least one of a next fibre channel frame, a next SATA frame, and a next SAS frame is processed by the conversion module.

14. A method comprising:
analyzing an incoming command of an initiator and performing a conversion of the incoming command to a format of an output line;
determining whether the incoming command is compatible with the output line;
processing the incoming command internally if it is incompatible with the output line by applying an algorithm; and
communicating the incoming command to a destination device if it is compatible with the output line.

15. The method of claim 14 further comprising updating an expected state of a next frame of the initiator using data provided in the command.

16. The method of claim 14 further comprising validating an incoming frame using at least one of a SAS, SATA, and a fibre channel protocol, and validating the initiator of the frame using a SCSI protocol.

17. The method of claim 14 further comprising processing a header data of the command in at least one queue structure and processing a payload data of the command in at least one payload buffer.

18. The method of claim 14 in a form of a machine-readable medium embodying a set of instructions that, when executed by a machine, cause the machine to perform the method of claim 14.

19. A network, comprising:
a data processing system coupled to a plurality of SAS devices and a plurality of SATA devices through a first fibre channel network and a second fibre channel network;
a first translation dongle to process data between at least one of the plurality of SAS devices and the data processing system through the first fibre channel network and the second fibre channel network; and
a second translation dongle to process data between at least one of the plurality of SATA devices and the data processing system through the first fibre channel network and the second fibre channel network.

20. The network of claim 19 wherein the second translation dongle to include at least two ports that provide multiple paths between the at least one of the plurality of SATA devices and the data processing system.
